(19) United States
(12) Patent Application Publication
(10) Pub. No.: US 2007/0040044 A1
(43) Pub. Date: Feb. 22, 2007

(54) Stream nozzle

(76) Inventor: Kenneth R. Lavacot, Yorba Linda, CA (US)

Correspondence Address: AVERILL & VARN, 8244 PAINTER AVE., WHITTIER, CA, 90602, US

(21) Appl. No.: 11/205,471

(22) Filed: Aug. 16, 2005

(51) Int. Cl. B05B 15/10; B05B 15/08

(52) U.S. Cl. 239/207; 239/587.1

(57) ABSTRACT

A stream nozzle resides between a water source and a sprinkler nozzle and provides a stream of water for watering a bush, shrub, or tree. The stream nozzle may either reside between a fixed height riser and a nozzle, or under the nozzle of a pop-up sprinkler. In the case of a fixed height riser, the stream nozzle may be attached to an adapter or directly to the riser. In the case of a pop-up sprinkler, the stream nozzle is preferably attached to an independently rotatable collar below the nozzle. The stream nozzle is preferably adjustable in elevation angle and in azimuth angle.

### BACKGROUND OF THE INVENTION

The present invention relates to irrigation and in particular to providing a directed stream of water to shrubs, trees, and the like.

Plants are generally used to provide inviting outdoor scenery. Often plants are introduced into areas where they do not naturally occur and in many instances these areas do not receive sufficient rainfall to support the plants. In these instances, irrigation must be utilized to provide sufficient water to the plants.

The most common form of irrigation comprises spray nozzles which spray a pattern of water onto a planted area. The nozzles may be a round pattern, a half round pattern, a quarter round pattern, a rectangular pattern, or the like. All of these patterns have a common problem of providing a spray to an area, versus targeting a single plant. As a result, water is spayed onto areas not requiring irrigation. Further, some plants benefit from deep watering. Specifically, it is desire: to saturate a small area around the plant to promote deep root growth. When known spray nozzles are used, a large surface area is uniformly watered, and shallow root growth results.

One alternative to using spray nozzles is a drip irrigation system. Such drip irrigation systems include manifolds and individual lines running to each plant. While a drip irrigation system may provide the desired concentration and resulting deep watering required for some plants, the numerous lines may be inadvertently cut or moved out of their original positions during subsequent yard work. A tree or shrub may die due to lack of water before the damage to the drip system is recognized.

There is thus a need for an irrigation system which provides directed watering without individual lines running to each plant.

### BRIEF SUMMARY OF THE INVENTION

The present invention addresses the above and other needs by providing a stream nozzle which resides between a water source and a sprinkler nozzle and provides a stream of water for watering a bush, shrub, or tree. The stream nozzle may reside either between a fixed height riser and a nozzle, or under the nozzle of a pop-up sprinkler. In the case of a fixed height riser, the stream nozzle may be attached to an adapter or directly to the riser. In the case of a pop-up sprinkler, the stream nozzle is preferably attached to an independently rotatable collar below the nozzle. The stream nozzle is preferably adjustable in elevation and in azimuth.

In accordance with one aspect of the invention, there is provided a stream watering apparatus comprising a water source, a sprinkler nozzle in fluid communication with the water source, and stream nozzle residing between the water source and the sprinkler nozzle. The stream nozzle is adjustable to independently change an elevation angle of the stream nozzle and an azimuth angle of the stream nozzle, relative to the sprinkler nozzle.

In accordance with another aspect of the invention, there is provided a watering system comprising a water source, underground water lines, risers connected to the underground water lines, a sprinkler nozzle in fluid communication with the risers, and a stream nozzle residing between the water source and the sprinkler nozzle. The stream nozzle is adjustable to independently change an elevation angle of the stream nozzle and an azimuth angle of the stream nozzle, relative to the sprinkler nozzle.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a prior art sprinkler system.

FIG. 2 is a sprinkler system with stream nozzles according to the present invention residing between water sources and sprinkler nozzles.

FIG. 3A shows the stream nozzle connected to an adapter according to the present invention.

FIG. 3B shows the stream nozzle connected directly to a riser.

FIG. 4 shows a cross-sectional view of the adapter taken along line 4-4 of FIG. 3A.

FIG. 5 shows a detailed view of an fitting configured for cooperation with the adapter.

FIG. 6 shows a cross-sectional view of a second fitting according to the present invention, taken along line 6-6 of FIG. 3B.

FIG. 7 is a detailed view of the second fitting.

FIG. 7A is a needle valve configured for cooperation with the second fitting.

FIG. 8 is a third fitting including a pressure regulator.

FIG. 9 is a pop-up sprinkler including a stream nozzle according to the present invention.

FIG. 10 is a pop-up sprinkler with the stream nozzle attached by a nozzle fixture.

FIG. 11 is a front view of the stream nozzle attached to a pop-up stem.

FIG. 12 is a cross-sectional view of the stream nozzle attached to the pop-up stem, taken along line 12-12 of FIG. 11.

FIG. 13 is a front view of the stream nozzle attached to a pop-up stem by the nozzle fixture.

FIG. 14 is a cross-sectional view of the stream nozzle attached to the pop-up stem by the nozzle fixture, taken along line 14-14 of FIG. 13.

FIG. 15 is a top view of a half circle sprinkler pattern from a sprinkler nozzle and a water stream from the stream nozzle.

FIG. 16 is a second pop-up sprinkler nozzle including a stream nozzle according to the present invention.

FIG. 17 is a third pop-up sprinkler nozzle with the stream nozzle attached by the nozzle fixture.

FIG. 18 is a front view of the stream nozzle attached to the second sprinkler nozzle.

FIG. 19 is a cross-sectional view of the stream nozzle attached to the second sprinkler nozzle, taken along line 19-19 of FIG. 18.

FIG. 20 is a front view of the stream nozzle attached to the third sprinkler nozzle by the nozzle fixture.

FIG. 21 is a cross-sectional view of the stream nozzle attached to the third sprinkler nozzle by the nozzle fixture, taken along line 21-21 of FIG. 20.

FIG. 22 is a front view of the stream nozzle attached to the rotating collar by swedging, the rotating collar residing above a sprinkler nozzle.

FIG. 23 is a front view of the stream nozzle attached to the rotating collar by the nozzle fixture, the rotating collar residing above a sprinkler nozzle.

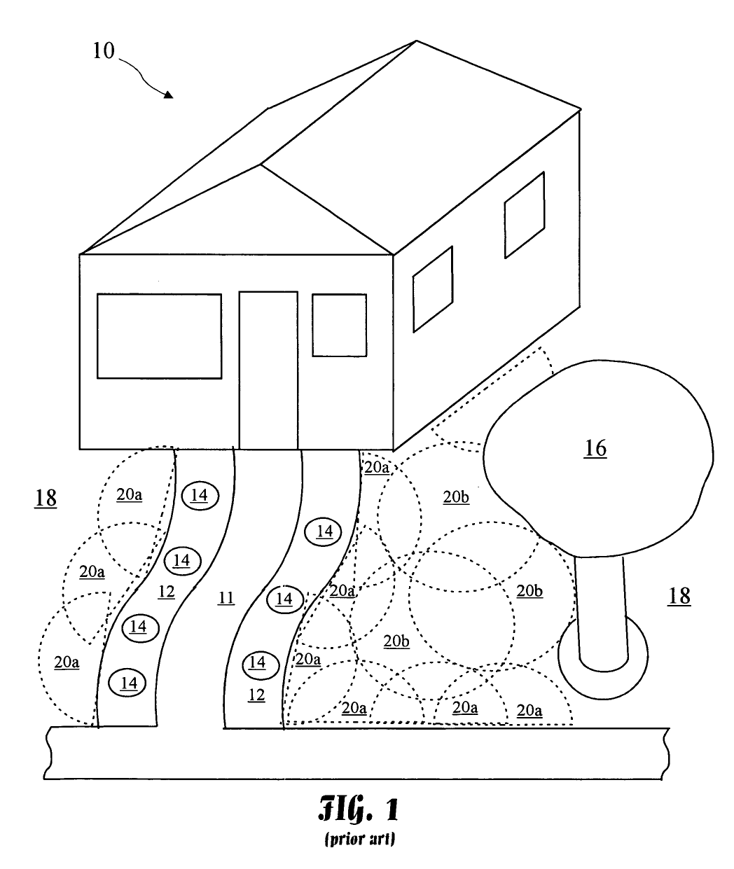

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

A prior art sprinkler system is shown arranged around a home 10. The sprinkler system includes half circle pattern sprinklers 20a and full circle pattern sprinklers 20b. Other sprinkler patterns such as quarter pattern, strip pattern, and the like are commonly used. Planted areas around the home 10 include planters 12 along a walkway 11, and lawns 18. While the sprinklers 20a and 20b provide a uniform coverage desirable for the lawns 18, they do not provide the concentrated coverage desirable for shrubs 14 or trees 16.

An improved sprinkler system with stream nozzles according to the present invention is shown in FIG. 2. The stream nozzles provide water streams 22 for concentrated watering of shrubs 14, trees 16, and the like. The stream nozzles are further configured to augment existing sprinklers and thus do not require additional sprinkler lines to be installed. The water streams 22 may further be used to provide water to any object requiring periodic addition of water, for example, fountains, bird baths, ponds, and the like.

A first stream nozzle 38a connected between a riser 24 and a sprinkler nozzle 26 by an adapter 28, is shown in FIG. 3A. The adapter 28 generally includes a female-threaded end for connecting to the riser 24, and a male-threaded end for the nozzle 26. The adapter 28 may thus be added to an existing sprinkler 26 position by removing the sprinkler 26 from the riser 24, screwing the adapter 28 onto the riser 24, and screwing the sprinkler 26 onto the adapter 28. The adapter includes a shoulder 34 which may be molded into the adapter 28. The shoulder 34 receives a first fitting (for example an elbow) 32a, and a bendable arm 36 slides over the fitting 32a. The stream nozzle 38a is inserted into the arm 36 and held in place on the arm 36 by a friction fit, barbs, glue, clamp, or by any means suitable for holding the stream nozzle 38a on the arm 36. The arm is similarly held in place on the shoulder 32a.

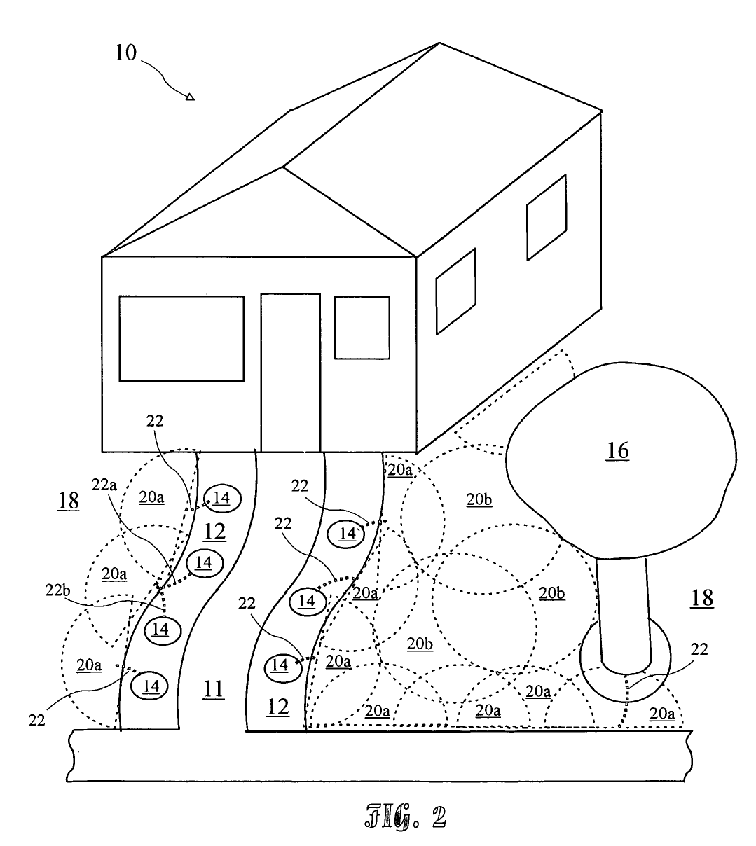

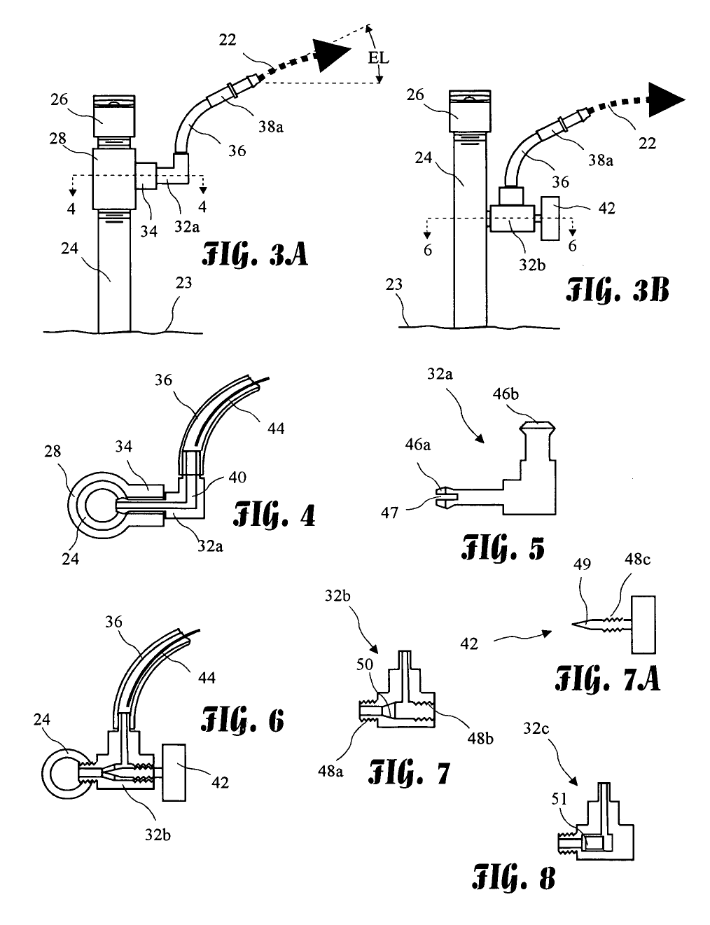

The fitting 32a may be straight or may be an angled elbow, and is preferably a 90 degree elbow. If the fitting 32a is an elbow, the fitting may be rotated in the shoulder 34 to aim the stream nozzle 38b. Further, the arm 36 is configured to retain a shape once bent, and to retain a new shape when bent again. The arm preferably is a flexible tide with a metal wire 44 (see FIG. 4) running through the tube.

The stream nozzle 38a is shown connected directly to the riser 24 in FIG. 3B. A second fitting 32b penetrates a wall of the riser 24, and includes a needle valve 42 for adjusting the flow of water to the stream nozzle 38a.

A cross-sectional view of the adapter 28 taken along line 4-4 of FIG. 3A is shown in FIG. 4. The fitting 32a extends through the shoulder 34 and into the interior of the adapter 28, thus into fluid communication with water provided by the riser 24 to the sprinkler nozzle 26. A passage 40 in the fitting 32a carries the water to the arm 36. The wire 44 resides inside the arm 36 to hold a position the arm 36 is bent into. The arm 36 may also comprise structure to retain shape when bent, for example, the arm 36 may be a corrugated tube made from metal, plastic, or any water compatible material, may be ball joint tubing, or the like.

A detailed view of an fitting 32a is shown in FIG. 5. The fitting 32a preferably includes a first flair 46a for retaining the fitting 32a in the adapter 28, and a second flair 46b for retaining the arm 44 on the fitting 32a. A slice 47 preferably separates the flair 46a to facilitate insertion of the fitting 32a into the adapter 28.

A cross-sectional view of a second fitting 32b inserted into a riser 24, taken along line 6-6 of FIG. 3B, is shown in FIG. 6, and a cross-sectional view of the fitting 32b alone is shown in FIG. 7. The fitting 32b includes first threads 48a for attaching (or screwing) the fitting 32b into the riser 24. The fitting 32b is preferably made from metal, and the threads 48a are configured to self tap into an appropriate size hole drilled (or otherwise formed) in a wall of the riser 24. The arm 36 attaches to the fitting 32b in a similar fashion as to the fitting 32a, and a flair 46b (see FIG. 5) may similarly be provided to retain the arm 36 on the fitting 32b.

The needle valve 42, configured for cooperation with the second fitting 32b, is shown in FIG. 7A. The needle valve 42 includes a valve tip 49 which cooperates with the valve seat 50 (see FIG. 7) to adjust the flow of water to the stream nozzle 38a (see FIG. 3B), and third threads 48c for advancing the needle valve 42 into the fitting 32b.

A third fitting 32c with a pressure regulator 51 is shown in FIG. 8. The pressure regulator may be similar to the pressure regulator incorporated into the stem of the Rainbird 1800-PRS pop-up sprinkler. Such pressure regulator is advantageous where water pressure may vary during, and maintains the aim of the water stream 22.

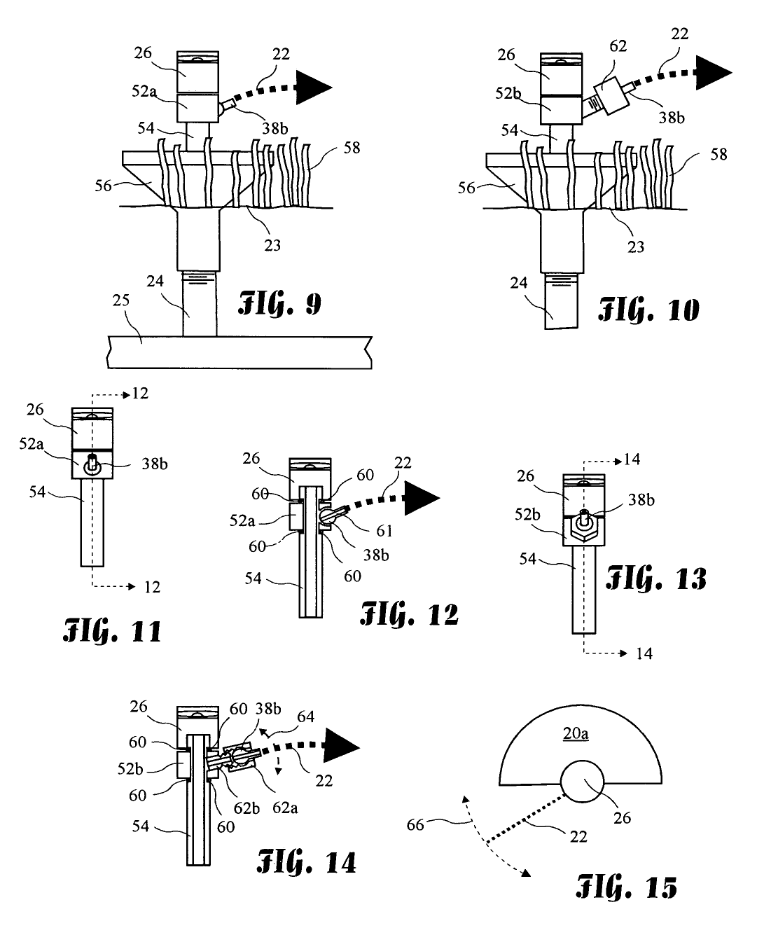

A pop-up sprinkler including a second stream nozzle 38b according to the present invention is shown in FIG. 9. The pop-up sprinkler resides close to the ground 23 and generally approximately flush with grass 58. The pop-up sprinkler receives water from the riser 24. A first rotatable collar 52a resides under the sprinkler nozzle 26, and a second stream nozzle 38b is attached to the collar 52. The collar 52a allows the stream nozzle 38b to be aimed in azimuth (see FIG. 15) independently from the sprinkler nozzle 26.

A pop-up sprinkler with the stream nozzle 38b attached by a nozzle fixture 62 is shown in FIG. 10. The fixture 62 is attached to a second rotatable collar 52b.

A front view of the collar 52a and stream nozzle 38b attached to a pop-up stem 54, below the sprinkler nozzle 26, is shown in FIG. 11, and a cross-sectional view of the stream nozzle attached to the pop-up stem, taken along line 12-12 of FIG. 11 is shown in FIG. 12. The collar 52a preferably resides between seals (for example o-rings) 60, providing a seal, and allowing independent rotation of the collar 52a with respect to the sprinkler nozzle 26. The stream nozzle 38b is swedged into the collar 52a to provide a snug (or friction) fit, allowing adjustment of the stream nozzle 38b and holding the position of the stream nozzle 38b after adjustment.

A front view of the stream nozzle 38b attached to the pop-up stem 54 by a nozzle fixture 52b is shown in FIG. 13, and a cross-sectional view of the stream nozzle 38b attached to the pop-up stem 54 by the nozzle fixture 52b, taken along line 14-14 of FIG. 13, is shown in FIG. 14. The fixture 62 comprises a fixture base pressed into the collar 52b, and a fixture nut 62b for holding the stream nozzle 38b in the fixture 62. The stream nozzle 38b may be adjusted by loosening the fixture nut 62b, and held in position by tightening the fixture nut 62b. Water flowing through the stem 54 to the sprinkler nozzle 26 may pass through the center of the fixture 62 and into the stream nozzle 38b.

A top view of a half circle sprinkler pattern 20a from a sprinkler nozzle 26 and a water stream 22 from the stream nozzle 38a or 38b is shown in FIG. 15. The stream nozzle 38a may be adjusted in azimuth along arc 66 by tightening the sprinkler nozzle 26 more or less (as is typically done to adjust a sprinkler nozzle), and by bending the arm 36. The stream nozzle 38b may be adjusted in azimuth along arc 66 by rotating the collar 52a or 52b.

A second pop-up sprinkler nozzle 26a including the stream nozzle 38b is shown in FIG. 16. The pop-up sprinkler nozzle 26a includes a stream nozzle 38b for providing a stream 22. The stream nozzle 38b is held in place in the same manner as described in FIGS. 9, 11, and 12.

A third pop-up sprinkler nozzle 26b with the stream nozzle 38b attached by the nozzle fixture 62 is shown in FIG. 17. The nozzle fixture 62 is held in place in the same manner as described in FIGS. 10, 13, and 14.

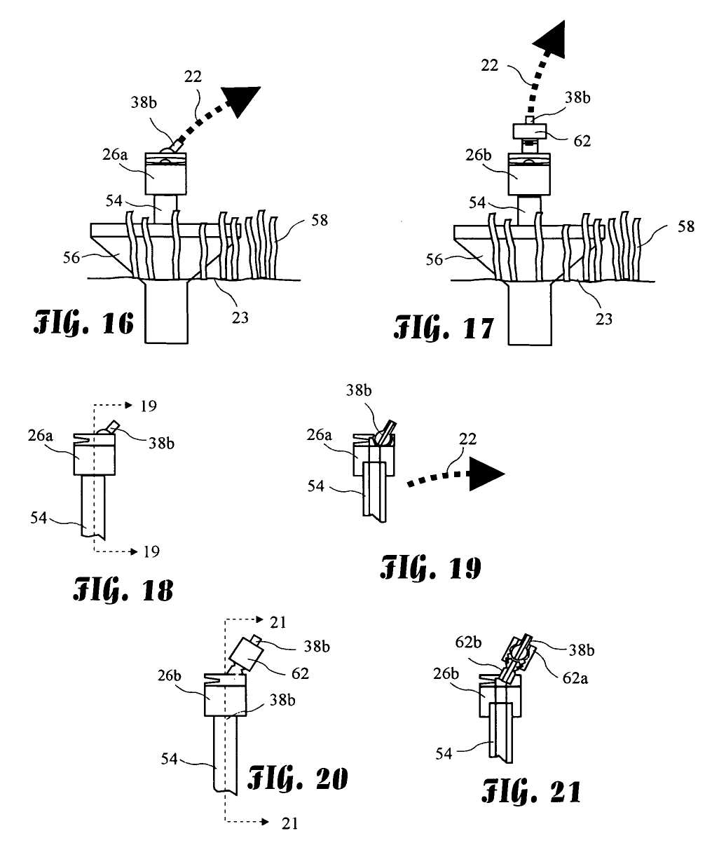

A front view of the stream nozzle 38b attached to the second sprinkler nozzle 26a is shown in FIG. 18, and a cross-sectional view of the stream nozzle attached to the second sprinkler nozzle, taken along line 19-19 of FIG. 18. The second sprinkler nozzle 26a thus provides for attaching a stream nozzle directly to the sprinkler nozzle 26a and does not require a rotating collar between the water source and the sprinkler nozzle as described in FIGS. 9, 11, and 12.

A front view of the stream nozzle 38b attached to the third sprinkler nozzle 26b by the nozzle fixture 62 is shown in FIG. 20, and a cross-sectional view of the stream nozzle 38b attached to the third sprinkler nozzle 26b by the nozzle fixture 62, taken along line 21-21 of FIG. 20, is shown in FIG. 21. The third sprinkler nozzle 26b thus provides for attaching a stream nozzle 38b directly to the sprinkler nozzle 26a using the nozzle fixture 62, and does not require a rotating collar between the water source and the sprinkler nozzle as described in FIGS. 10, 13, and 14.

A front view of the stream nozzle 38b attached to a third collar 52c by swedging is shown in FIG. 22. The collar 52c resides above a second sprinkler nozzle 26b. The stream nozzle 38b is attached in a manner similar to that described in FIG. 12. The sprinkler nozzle 26b may be rotatably connected to the stem 54 in the same manner as the collar 52a shown in FIG. 12, or the collar 52c may be a rotating collar.

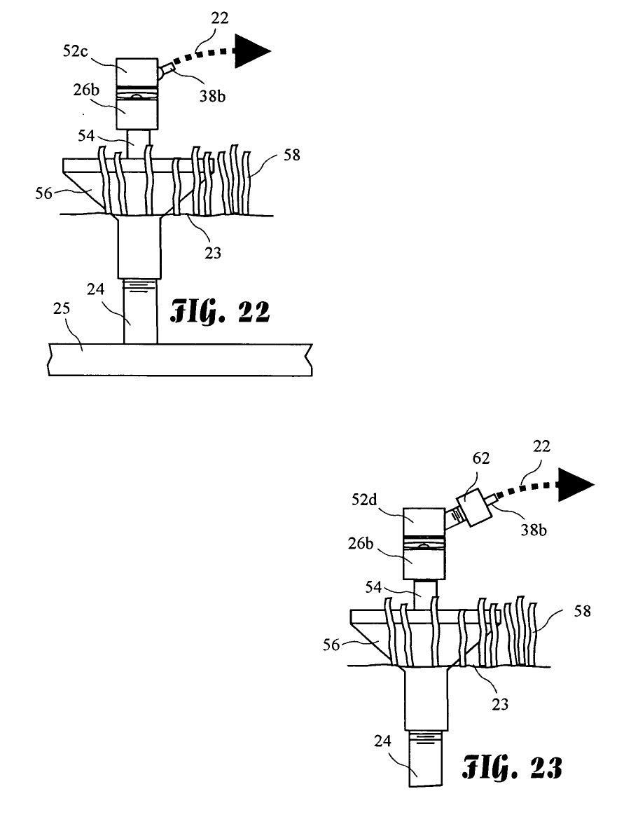

A front view of the stream nozzle 38b attached to a fourth collar 52d by the nozzle fixture 62 is shown in FIG. 23. The collar 52d resides above the sprinkler nozzle 26b, but is otherwise similar to FIG. 14. The sprinkler nozzle 26b may be rotatably connected to the stem 54 in the same manner as the collar 52a shown in FIG. 12, or the collar 52d may be a rotating collar.

While the invention herein disclosed has been described by means of specific embodiments and applications thereof, numerous modifications and variations could be made thereto by those skilled in the art without departing from the scope of the invention set forth in the claims.

I claim:

1. A stream watering apparatus comprising:
a water source;
a sprinkler nozzle in fluid communication with the water source; and
a stream nozzle sharing the water source for the sprinkler nozzle, the stream nozzle being adjustable to change an elevation angle of the stream nozzle.

2. The apparatus of claim 1, wherein the stream nozzle is adjustable to change an azimuth angle of the stream nozzle.

3. The apparatus of claim 1 further including a flow adjustment for the stream nozzle.

4. The apparatus of claim 1 further including a pressure regulator regulating a pressure of water provided to the stream nozzle.

5. The apparatus of claim 1, further including a bendable arm to adjust the azimuth angle and the elevation angle.

6. The apparatus of claim 5, wherein the bendable arm comprises a flexible tube and a wire residing inside the flexible tube.

7. The apparatus of claim 5, wherein the bendable arm is in fluid communication with a sprinkler riser.

8. The apparatus of claim 7, wherein the bendable arm is connected to an adapter residing between the sprinkler riser and a sprinkler nozzle.

9. The apparatus of claim 7, wherein the bendable arm is held in fluid communication with the sprinkler riser by a fitting passing through a wall of the sprinkler riser.

10. The apparatus of claim 1, wherein the stream nozzle is pivotable to adjust the azimuth angle and the elevation angle.

11. The apparatus of claim 1, wherein:
the apparatus comprises a pop-up sprinkler; and
an independently rotating collar resides below the sprinkler nozzle; and
the stream nozzle is connected to the collar, thereby providing an adjustable azimuth for the stream nozzle.

12. The apparatus of claim 11, wherein:
the pop-up sprinkler includes a stem for carrying water to the sprinkler nozzle; and
a seal resides between the collar and the stem.

13. The apparatus of claim 11, wherein a seal resides between the stream nozzle and sprinkler nozzle.

14. The apparatus of claim 11, wherein the stream nozzle resides in a recess in the collar.

15. The apparatus of claim 11, wherein:
a nozzle fixture is connected to the collar; and
the stream nozzle resides in the nozzle fixture.

16. The apparatus of claim 11, wherein:
a fixture nut holds the stream nozzle in the nozzle fixture; and the fixture nut may be loosened to allow adjustment of the stream nozzle.

17. A stream watering apparatus comprising:
a water source;
a sprinkler nozzle in fluid communication with the water source; and
a stream nozzle residing between the water source and the sprinkler nozzle, the stream nozzle being adjustable to independently change an elevation angle of the stream nozzle and an azimuth angle of the stream nozzle, relative to the sprinkler nozzle.

18. The apparatus of claim 17, wherein the stream nozzle resides on an end of a bendable arm, the bendable arm comprising a flexible tube and a wire residing inside the flexible tube.

19. The apparatus of claim 17, wherein the stream nozzle is connected to a rotating collar residing under the sprinkler nozzle.

20. A watering system comprising:
a water source;
water lines;
risers connected to the water lines;
a sprinkler nozzle in fluid communication with the risers; and
a stream nozzle residing between the water source and the sprinkler nozzle, the stream nozzle being adjustable to independently change an elevation angle of the stream nozzle and an azimuth angle of the stream nozzle, relative to the sprinkler nozzle.
